(19) United States
(12) Patent Application Publication
(10) Pub. No.: US 2013/0246795 A1
(43) Pub. Date: Sep. 19, 2013

(54) SYSTEM, METHOD, AND COMPUTER PROGRAM PRODUCT FOR ALLOWING CONTENT TRANSFER BASED ON A SIGNATURE AND A CONTEXT THEREOF

(71) Applicants: Rajesh Shinde, Hyderabad (IN); Srikanth Chowdary Marri, Bangalore (IN)

(72) Inventors: Rajesh Shinde, Hyderabad (IN); Srikanth Chowdary Marri, Bangalore (IN)

(21) Appl. No.: 11/840,737

(22) Filed: Aug. 17, 2007

(51) Int. Cl. H04L 9/00

(52) U.S. Cl. 713/176

(57) ABSTRACT

A system, method, and computer program product are provided for conditionally allowing a transfer of content, based on a signature and a context. In operation, a signature for content is identified. In addition, a context of an attempt to transfer the content is identified. Furthermore, the transfer is conditionally allowed, based on the signature and the context.

### FIELD OF THE INVENTION

The present invention relates to information security, and more particularly to secure content transfer in a network.

### BACKGROUND

With the increased use of online and handheld/mobile storage devices, information security has become a serious issue for all enterprises. In many situations, data can easily end up in the wrong hands, deliberately or accidentally. Every day, users transmit confidential information via e-mail, web mail, instant messages, and other media. Users also send private information to physical devices such as printers, faxes, removable storage devices, and other various physical devices. Still yet, corporate employees, contractors, and affiliates routinely access corporate data via remote access, local area networks (LANs), or wireless connections.

These types of access create a myriad of potential entry points for security threats to infiltrate the network and may even introduce unknown risks due to altered or stolen data. There is thus a need for addressing these and/or other issues associated with the prior art.

### SUMMARY

A system, method, and computer program product are provided for conditionally allowing a transfer of content, based on a signature and a context. In operation, a signature for content is identified. In addition, a context of an attempt to transfer the content is identified. Furthermore, the transfer is conditionally allowed, based on the signature and the context.

### DESCRIPTION OF THE DRAWINGS

FIG. 1 illustrates a network architecture, in accordance with one embodiment.

FIG. 2 shows a representative hardware environment that may be associated with the servers and/or clients of FIG. 1, in accordance with one embodiment.

FIG. 3 shows a method for conditionally allowing a transfer of content based on a signature and a context, in accordance with one embodiment.

FIG. 4 shows a system for conditionally allowing a transfer of content based on a signature and a context, in accordance with one embodiment.

FIG. 5 shows a method for conditionally allowing a transfer of content based on a signature and a context, in accordance with another embodiment.

### DETAILED DESCRIPTION

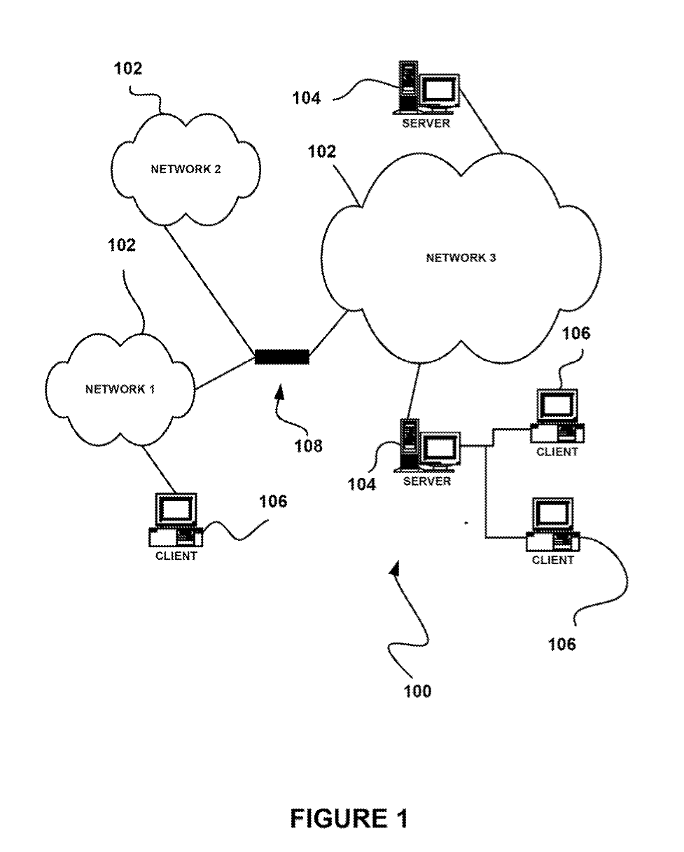

FIG. 1 illustrates a network architecture 100, in accordance with one embodiment. As shown, a plurality of networks 102 is provided. In the context of the present network architecture 100, the networks 102 may each take any form including, but not limited to a local area network (LAN), a wireless network, a wide area network (WAN) such as the Internet, peer-to-peer network, etc.

Coupled to the networks 102 are servers 104 which are capable of communicating over the networks 102. Also coupled to the networks 102 and the servers 104 is a plurality of clients 106. Such servers 104 and/or clients 106 may each include a desktop computer, lap-top computer, hand-held computer, mobile phone, personal digital assistant (PDA), peripheral (e.g. printer, etc.), any component of a computer, and/or any other type of logic. In order to facilitate communication among the networks 102, at least one gateway 108 is optionally coupled therebetween.

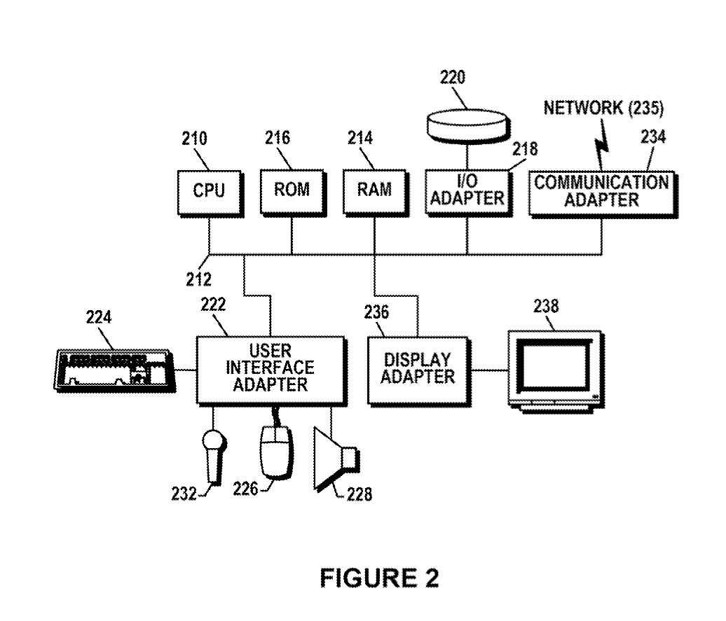

FIG. 2 shows a representative hardware environment that may be associated with the servers 104 and/or clients 106 of FIG. 1, in accordance with one embodiment. Such figure illustrates a typical hardware configuration of a workstation in accordance with one embodiment having a central processing unit 210, such as a microprocessor, and a number of other units interconnected via a system bus 212.

The workstation shown in FIG. 2 includes a Random Access Memory (RAM) 214, Read Only Memory (ROM) 216, an I/O adapter 218 for connecting peripheral devices such as disk storage units 220 to the bus 212, a user interface adapter 222 for connecting a keyboard 224, a mouse 226, a speaker 228, a microphone 232, and/or other user interface devices such as a touch screen (not shown) to the bus 212, communication adapter 234 for connecting the workstation to a communication network 235 (e.g., a data processing network) and a display adapter 236 for connecting the bus 212 to a display device 238.

The workstation may have resident thereon any desired operating system. It will be appreciated that an embodiment may also be implemented on platforms and operating systems other than those mentioned. One embodiment may be written using JAVA, C, and/or C++ language, or other programming languages, along with an object oriented programming methodology. Object oriented programming (OOP) has become increasingly used to develop complex applications.

Of course, the various embodiments set forth herein may be implemented utilizing hardware, software, or any desired combination thereof. For that matter, any type of logic may be utilized which is capable of implementing the various functionality set forth herein.

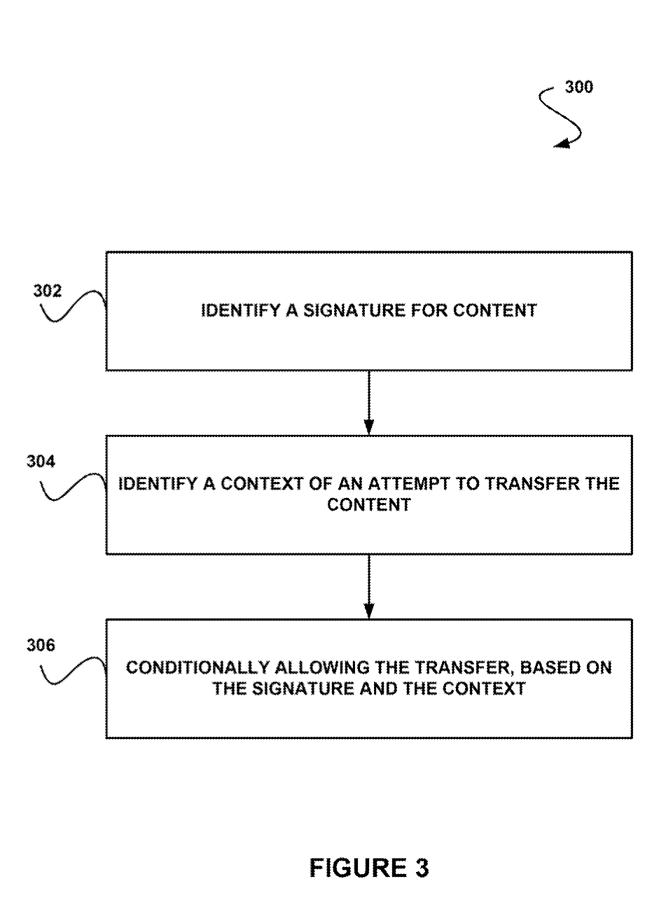

FIG. 3 shows a method 300 for conditionally allowing a transfer of content based on a signature and a context, in accordance with one embodiment. As an option, the method 300 may be implemented in the context of the architecture and environment of FIGS. 1 and/or 2. Of course, however, the method 300 may be carried out in any desired environment.

As shown in operation 302, a signature for content is identified. In the context of the present description, content refers to any information or data capable of having a signature. For example, in various embodiments, content may include, but is not limited to data from confidential or classified documents, various proprietary documents, computer code, drawings, any digital work product, and/or any other data or information that meets the above definition.

In the context of the present description, a signature refers to any feature used to identify or label content. For example, in various embodiments, the signature may include, but is not limited to a key, a code, a seal, a certificate, an identifier, a hash, and/or any feature that meets the above definition.

Furthermore, in some embodiments, the signature may be based on various criteria. For example, in various embodiments, the signature may be based on user information, application information, address information (e.g. MAC address information), file or document information, the content itself, and/or any other information from which the signature may be generated. In one embodiment, the signature may be identified based on data randomly extracted from the content.

Additionally, in one embodiment, identification of the signature may include generating the signature of the content. In another embodiment, identification of the signature may include utilizing a predetermined signature of the content. For example, the signature may be stored in a database. In this case, the signature may be stored with various other information relating to the signature and/or corresponding content.

As shown in operation 304, a context of an attempt to transfer the content is identified. In various embodiments, identifying the context may involve identifying information relating to the transfer such as the identification of a user attempting the transfer, an intended recipient, a device attempting or otherwise involved with the transfer, an involved application, a service used in the attempted transfer, network traffic at a time of the attempt, a time and day of the attempted transfer, details of the content, and/or any other contextual information relating to the attempt to transfer the content.

Additionally, the content transfer may be attempted in a variety of ways. For example, the attempt may be initiated from any number of devices such as a computer, a PDA, a mobile phone or other mobile device, and/or any other device capable of transferring the content. In various embodiments, the attempted transfer may include e-mail, web mail, instant messaging, and/or any other type of service capable of transferring information.

Furthermore, in various embodiments, the transfer may be directed to any number of devices such as printers, fax machines, removable storage devices (e.g. USB drives, removable hard drives, etc.), computers, portable devices, and/or any other device capable of receiving information. Additionally, the transfer may be attempted over remote or local networks. Such networks may take any form including, but not limited to a LAN, a wireless network, a WAN such as the Internet, a peer-to-peer network, etc.

Further, the transfer is conditionally allowed, based on the signature and the context. Note operation 306. In the context of the present description, such transfer may be conditionally allowed in any way that is a function of both the signature and the context.

For example, in one embodiment, the signature may be compared to a plurality of known signatures. As an option, the known signatures may be stored in a database of known signatures. As a further option, the aforementioned context may be included in the signature.

In another embodiment, the transfer may be conditionally allowed based on rules. Strictly as an option, the rules may be a function of the context. For example, the rules may be applied to determine whether to allow the transfer based on the context of the attempted transfer. In one embodiment, the rules may be applied based on the comparison of the signature to the plurality of known signatures.

For example, if a match for the signature is found, a rule or set of rules related to the context of the attempted transfer may be applied. In the case where no match is found, various embodiments may set forth different outcomes based on a predetermined configuration. For example, in one embodiment, if a signature match is not found, the transfer may be allowed.

In another embodiment, if a signature match is not found, the transfer may be prohibited. In still another embodiment, if a signature match is not found, a rule or set of rules may be applied to determine whether the content transfer is allowed. As an option, the determination of whether to allow the transfer may be automatically delegated to a person of authority.

More illustrative information will now be set forth regarding various optional architectures and features with which the foregoing technique may or may not be implemented, per the desires of the user. It should be strongly noted that the following information is set forth for illustrative purposes and should not be construed as limiting in any manner. Any of the following features may be optionally incorporated with or without the exclusion of other features described.

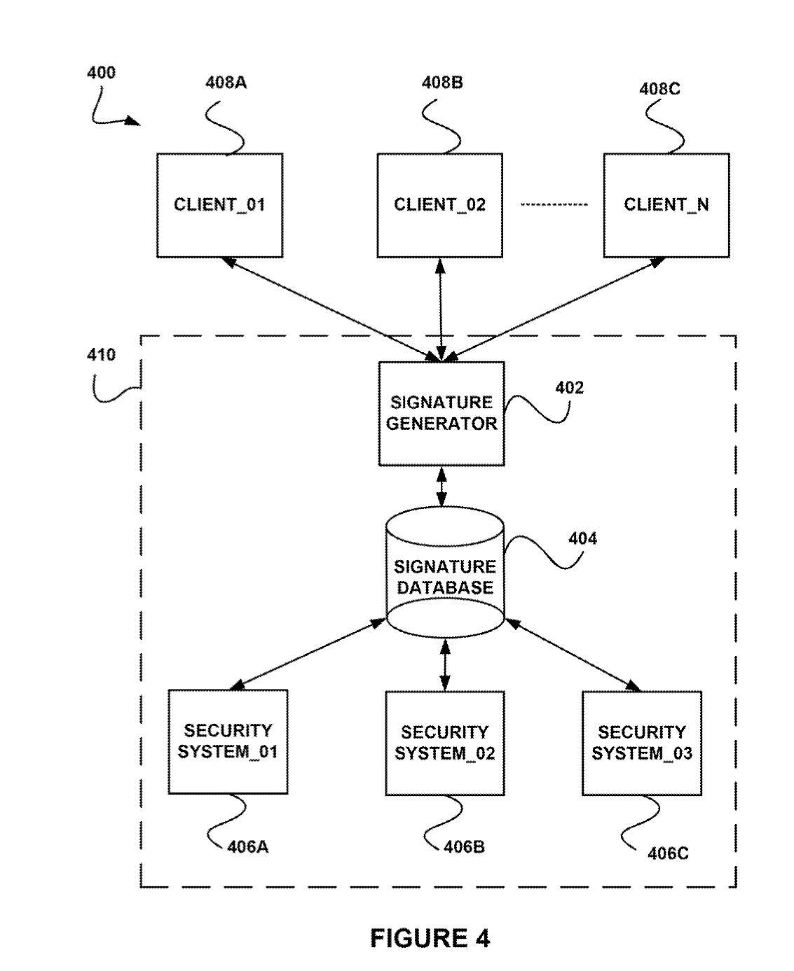

FIG. 4 shows a system 400 for conditionally allowing a transfer of content based on a signature and a context, in accordance with one embodiment. As an option, the system 400 may be implemented in the context of the architecture and environment of FIGS. 1-3. Of course, however, the system 400 may be implemented in any desired environment. It should also be noted that the aforementioned definitions may apply during the present description.

As shown, a signature generator 402 is provided. The signature generator 402 is in communication with a signature database 404. Additionally as shown, the signature generator 402 is in communication with a plurality of clients 408A-C. In the context of the present description, the clients 408A-C may represent any device capable of transferring or receiving content. In various embodiments, the clients 408A-C may represent computers, mobile devices (e.g. phones, PDAs), various hand-held computing devices, and/or any other type of device capable of transferring or receiving content.

In operation, the signature generator 402 identifies a signature for content. Such content may have been received as part of an attempted transfer by at least one of the clients 408A-C, for example. In one embodiment, identification of the signature may include generating the signature of the content. In another embodiment, identification of the signature may include identifying a predetermined signature of the content.

The signature may be based on various criteria. For example, in various embodiments, the signature may include information about a user who generated or modified the content, application information used to generate or modify the content, content origin information, file or document information (e.g. data in a file), information on a device used to generate the content, and/or any other information from which the signature may be generated. In one embodiment, the signature may include data randomly extracted from the content.

In addition to identifying a signature for the content, a context of the attempt to transfer the content is identified. In one embodiment, the signature generator 402 may identify the context. In another embodiment, a separate module may be used to identify the context.

In various embodiments, the context identified may include a variety of factors. For example, the context may include information of a user attempting the transfer, an intended recipient of the content, a device used in the attempted transfer, a device designated as an intended recipient of the content, an application used to transfer or potentially receive the transfer, etc. In one embodiment, such information may be information obtained within a specific network (e.g. a network enterprise).

As an option, the context may include network traffic information. In one embodiment, the context may include a day and time of the attempted transfer. In another embodiment, the context may include information on whether the day of the attempted transfer is a normal work day and/or during standard working hours.

Once the signature and context have been identified, it is determined whether the transfer is allowed. In one embodiment, determining whether the transfer is allowed involves comparing the signature to known signatures in the signature database 404. For example, the identified signature may be compared with the list of known signatures to determine whether there is a match in the signature database 404.

In one embodiment, the signature database 404 may include a list of documents and/or files which exist on a network. In such case, the list of documents and/or files may include corresponding signatures for such documents and/or files. Thus, the identified signature may be compared with the known signatures corresponding to the documents and/or files on the network.

If the signature matches a known signature in the database 404, it is then determined what criteria may allow for the transfer. In one embodiment, the known signatures in the database 404 may correspond to a rule or a set of rules which allow or prohibit the transfer of the content corresponding to that particular signature. In such case, the rules may correspond to the context of the attempted transfer.

Thus, the context may be evaluated with respect to the rules corresponding to the signature, and a determination may be made on whether to allow the transfer. For example, if the context of the attempted transfer is such that the rules do not permit the transfer, the transfer may be temporarily or permanently blocked or stopped. If the context of the attempted transfer is such that the rules do permit the transfer, the transfer may be allowed.

It should be noted that any number of rules may be implemented when determining whether the transfer should be allowed. In one embodiment, such rules may be configurable. In this case, an administrator or a controlling authority may configure and/or generate the rules. In various embodiments, the rules and/or signatures may be accessed and configured from a command prompt (e.g. a CUI mode) and/or from a graphic user interface (e.g. a GUI browser such as Internet Explorer, Fire fox, etc.).

In another embodiment, the rules may be automatically configured and/or generated. For example, a module may monitor various parameters to generate or modify rules for allowing transfers. In various embodiments, such parameters may include network traffic, typical times of system usage, times when a particular content is transferred, typical size of data transfers, and/or any other types of relevant parameters. In one embodiment, the module monitoring the various parameters may be the same module identifying the signatures (e.g. the signature generator 402). In another embodiment, separate modules may identify the signature and monitor the various parameters.

Additionally, as an option, the rules may be configured such that any determination on whether to allow the transfer is delegated to an authority. For example, upon comparison of the signature with the known signatures in the signature database 404, a signature match may be found. Upon finding the signature match, a rule corresponding to the known signature may indicate that, given the context, or under any context, manager approval is required to allow the transfer. As a result, the manager may be presented with a notification of the attempted transfer.

Such notification may be presented to the manger in a variety of ways, depending on system configuration. In various embodiments, the notification may include automatically generating and sending an email, fax, text message, instant message, and/or any other alert to an appropriate authority. In one embodiment, the notification may include automatically sending an alert to the manager which gives the manager an option of approving or rejecting the transfer.

As an option, the alert may be in the form of a GUI presented to the manager which includes information relating to the transfer. In various embodiments, the information may include user information, context information, device information, information about the time and day, location information (e.g. IP address, building number, location, etc.), and/or any other information relating to the transfer. Thus, the manager may utilize the information in order to determine whether to allow or reject the attempted transfer.

In one embodiment, the determination of whether to allow the transfer of the content may be delegated to an authority for any signatures corresponding to a particular set of files (e.g. confidential, classified, protected, etc.). In this case, any decision involving the movement of the file (e.g. location changes, copying, editing, etc.) may be delegated to the authority. This may allow an organization or individual to more closely monitor the transfer of certain content, such as content related to sensitive material.

Furthermore, in the event of a procedure failure or system glitch, or in a case where a questionable transfer is allowed by an authority figure, an alert may be sent to an administrator and/or logged into the signature database 404. This may allow the administrator to examine a time frame when a questionable event occurred to determine whether a transfer was completed without adequate screening. If such is the case, the administrator may rely on additional security features using a multi-layered security approach.

As an option, and as shown further in FIG. 4, the signature database may be in communication with a plurality of security systems 406A-C. In one embodiment, the security systems 406A-C may represent security applications deployed on a perimeter of a network. In various embodiments, the security systems 406A-C may represent antivirus engines, unwanted e-mail filters, firewalls, and/or any other type of security system or application. In one embodiment, the signature database 404 may allow the security systems 406A-C to access the signatures, rules, and/or other information stored in the signature database 404.

By allowing the security systems 406A-C to access the signatures and/or rules stored in the signature database 404, the security systems 406A-C may also be used to regulate content transfer. For example, if a user attempts to transfer a confidential file through FTP, HTTP, or a web service from outside of a defined perimeter, the content may be scanned using at least one of the security systems 406A-C. The security systems 406A-C may then access the signature database 404 to determine, based on the signature and the context, whether to allow the transfer, quarantine the content, or block the transfer.

Additionally, by allowing the security systems 406A-C to access the information stored in the signature database 404, a multi-layered security architecture may be provided. Such approach may allow for additional security of a network, information communicated in the network, and network resources. In one embodiment, communication between the signature database 404 and the security systems 406A-C may allow for endpoint policy enforcement, such as warning that the security system definitions (e.g. antivirus, and/or unwanted e-mail filter engine definitions) are out-of-date.

For example, a processor (e.g. the signature generator 402) may monitor a status of the security systems 406A-C. Thus, if the processor determines that security systems require updates, the processor may send a warning to an administrator. In one embodiment, the processor may also act in response to an attack.

For example, in one embodiment, the security systems 406A-C may store virus signatures and/or other security related data in the signature database 404. Thus, the signature generator 402 may utilize the virus signatures and/or the other security related data in the signature database 404 to take an action in response to an attack. The action may include any response to an attack, such as blocking a port or stopping an executable.

It should be noted that, although in the context of the present description the signature generator 402 is illustrated as communicating with the plurality of clients 408A-C, the signature generator 402 may also communicate with one or more servers, in another embodiment. Additionally, in FIG. 4, the signature generator 402, the signature database 404, and the security systems 406A-C are shown as part of an environment 410. In various other embodiments, the environment 410 may represent a client or a server environment.

As an option, the environment 410 may be a separate environment than an environment which includes the clients 408A-C. In one embodiment, the environment 410 may be in a different time zone than the clients 408A-C. In this case, the signature generator 402 may monitor usage of the clients 408A-C and operate according to the working schedule of users of the clients 408A-C and corresponding network.

In one embodiment, the signature generator 402 may “learn” the working schedule of the users of the clients 408A-C by monitoring usage of the network. The signature generator 402 may update the signature database 404 with information obtained by monitoring the use of the clients 408A-C and the corresponding network. In one embodiment, such information may be used to generate the rules.

By monitoring the use of the clients 408A-C and the corresponding network, the signature generator 402 may change with changing user/network conditions and update the signature database 404 with schedule, user activities, and user device behavior/characteristics. In one embodiment, the monitoring of the use of the clients 408A-C and the network flow may allow the signature generator 402 to go into a silent mode.

For example, if the signature generator 402 detects no activity on the clients 408-C or the network (e.g. holidays or non-working hours), the signature generator 402 may enter into silent mode or a monitor-only mode. By entering into such a mode, processing power may be preserved for other resources, for example. It should be noted, however, that the clients 408A-C and the network may still be monitored for content transfer when the signature generator 402 is in silent mode.

In the present description, operation of the system 400 may be independent of the mode of the clients 408A-C. For example, the operation of the system 400 may be independent of whether the operating system of one of the clients 408A-C is booted into a safe mode, debugging mode, or a standard mode. Optionally, an administrator may be alerted when the system is not running in normal mode during a particular time and date.

Additionally, in one embodiment, a signature may be issued to a device on a network, such as the clients 408A-C. As an option, the signature generator 402 may issue the signature to the devices. Furthermore, the device signatures may be stored in the signature database 404.

Thus, for any device introduced into the network, a signature of the device may be identified and compared to the signatures in the signature database 404. If it is determined that the device signature corresponds with a known allowed device signature, the device may be approved for activity (e.g. transfers). If it is determined that the device signature does not correspond with a known allowed device signature, or corresponds with a prohibited device signature, the device may be prohibited from activity.

Device signatures may be identified for any device on, or introduced to the network. In one embodiment, the device may be a hand-held or removable storage device (e.g. a personal disk drive, USB storage device, removable hard drive, PDA, IPOD, etc.). In such case, a signature of the hand-held device may be cross-checked with a list of approved device signatures in the signature database 404.

Similarly, the signature database 404 may include a list of approved ports in the network. Thus, upon activity of a port, a signature of the port may be compared to the list of approved port signatures in the database 404. Thus, any port and/or device activity may be approved based on signatures and rules, which may be stored in the signature database 404.

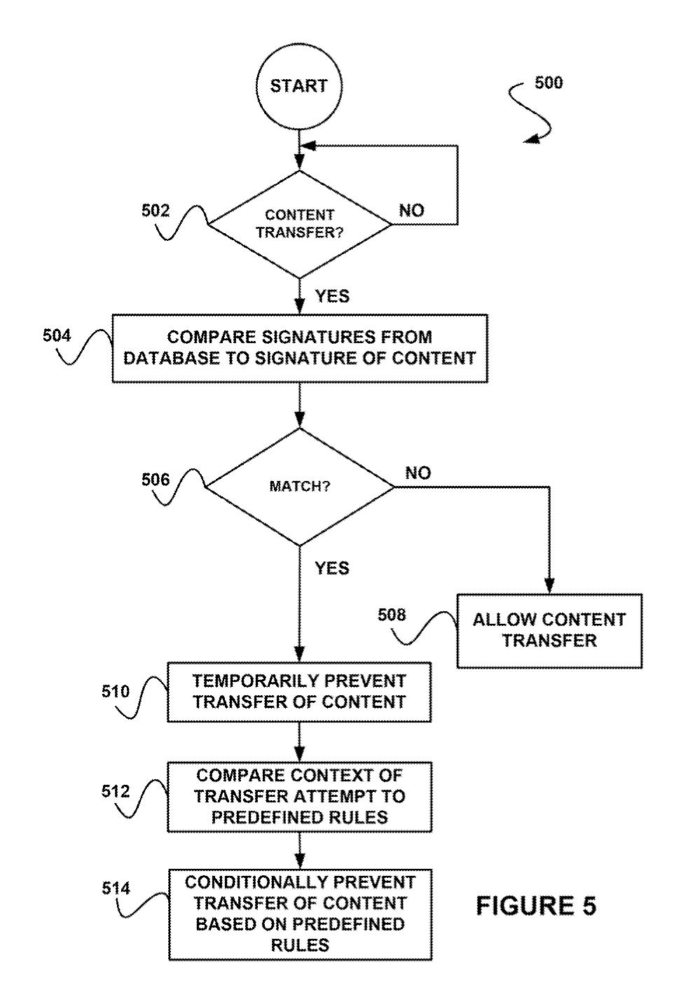

FIG. 5 shows a method 500 for conditionally allowing a transfer of content, based on a signature and a context, in accordance with another embodiment. As an option, the method 500 may be implemented in the context of the architecture and environment of FIGS. 1-4. Of course, however, the method 500 may be carried out in any desired environment. It should also be noted that the aforementioned definitions may apply during the present description.

As shown in operation 502, it is determined whether a content transfer is occurring. If it is determined that a content transfer is occurring, signatures from a database are compared to a signature of the content, as shown in operation 504. In one embodiment, the signature of the content may be generated by a signature generator. In another embodiment, the signature of the content may a predetermined signature included with the content.

Once the signatures from the database are compared to the content, it is determined whether there is a signature match, as shown in operation 506. If it is determined that there is a match in the database, the content transfer is temporarily prevented, as shown in operation 510. If it is determined that there is not a signature match, the content transfer is allowed, as shown in operation 508.

As an option, the signature may be identified based on data randomly extracted from the content. In some cases, a user may transfer a file in portions, or in subdivided parts. If this is the case, a signature identified based on data randomly extracted from the content may correspond to a known signature in the database. For example, a signature identified based on data randomly extracted from the content may correspond to key words and/or other characteristics of the known signature in the database.

Once the transfer has been temporarily prevented in operation 510, a context of the transfer attempt is compared to predetermined rules, as shown in operation 512. The predetermined rules may correspond to various information relating to the context. For example, such rules may relate to information of a user attempting the transfer, an intended recipient of the content, a device used in the attempted transfer, a device designated as the intended recipient of the content, an application used to transfer or potentially receive the transfer, and/or any other information relating to the attempted transfer.

Furthermore, the rules may be established in a number of ways. In one embodiment, the rules may be defined by a user. In such case, the user may be an administrator, or other individual with decision-making authority.

In another embodiment, the rules may be determined automatically by monitoring system and/or network use. For example, rules may be generated based on a time and day of typical usage. In such case, the typical usage may be determined by monitoring the system and/or network.

In one embodiment, such monitoring may be used to determine typical work days. In another embodiment, the monitoring may be used to determine a time zone. As an option, the monitoring may be accomplished using a module. In this case, such module may contribute to generating the rules. In still another embodiment, the rules may be determined using the module.

Once the context of the attempted transfer has been compared to the predetermined rules, the transfer is allowed or prevented. If the context of the attempted transfer is such that the rules do not permit the transfer, the transfer of the content is prevented, as shown in operation 514. In another embodiment, if the context of the attempted transfer is such that the rules permit the transfer, the transfer of the content may be allowed after verifying the identity of a source of the attempted transfer and/or an authorization of such source.

As an option, any transfer that is blocked or stopped may be reported. In various embodiments, the reporting may include notifying an administrator, Information Technology manager, security specialist, or any other responsible authority. The notification may include automatically generating and sending an email, fax, text message, instant message, and/or any other alert to the appropriate authority.

Such notification may include any information related to the attempted transfer. In various embodiments, the information may include user information, context information, device information, information about the time and day, location information (e.g. IP address, building number, location, etc.) and/or any other information relating to the transfer. Additionally, any information relating to any transfer or attempted transfer may be stored in the database. Thus, any blocked or stopped transfer may be logged for examination.

In one embodiment, if an unauthorized access is detected such that activity in which there is a risk of data being compromised or any activity detected which is not allowed, violates rules, etc., then the connection from the server may be immediately terminated and all entry points or access points (e.g. wireless, Ethernet etc.) to the network may be blocked for that particular computer, PDA, laptop or any sort of networking or computing device which can be used to compute or store data.

If abnormal behavior is detected, for instance activities which are not in the predefined set of rules, then the currently logged and active user account may be blocked temporarily as well as disabling all of the input and output devices of that particular system until the administrator allows all restrictions (e.g. after checking the security clearance of that particular system and removing all restrictions on the application or the physical layer of that particular computer, PDA, laptop or any sort of networking or computing device which can be used to compute or store data).

In one embodiment, the signature may be used to monitor traffic which is flowing in or out of a perimeter of a network so that information flow of the network may be tracked. Such information flow may be tracked and stored in the database, for example. In such case, the database may be integrated with other network security systems (e.g. antivirus systems, unwanted e-mail filters, Firewalls, etc.).

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method to be executed in conjunction with at least one processor, comprising:
within a content, identifying a signature;
identifying a context of an attempt to transfer the content; and
conditionally allowing the transfer, based on the signature and the context, wherein if the transfer is not allowed initially, an e-mail notification is sent and the transfer is delegated to an authoritative entity.

2. The method of claim 1, wherein the context is included in the signature.

3. The method of claim 1, wherein identifying the context includes identifying information about at least one of a day, a time, a user, and a device associated with the content.

4. The method of claim 1, wherein the signature is compared to a plurality of signatures.

5. The method of claim 4, wherein the transfer is conditionally allowed based on rules.

6. The method of claim 5, wherein the rules are a function of the context.

7. The method of claim 6, wherein the rules are applied based upon a result of the comparison.

8. The method of claim 5, wherein at least one of the rules is automatically generated.

9. The method of claim 8, wherein the at least one rule is automatically generated based on monitored network traffic.

10. The method of claim 5, wherein the rules are configurable by a user.

11. The method of claim 1, wherein identifying the signature for the content involves generating the signature for the content.

12. The method of claim 1, wherein identifying the signature for the content involves identifying a predetermined signature for the content.

13. The method of claim 1, wherein the attempt to transfer the content involves a device.

14. The method of claim 13, wherein the signature includes information about the device.

15. The method of claim 14, wherein the device is a removable storage device.

16. A non-transitory computer readable medium including a computer program, comprising:
computer code for identifying a signature within a content;
computer code for identifying a context of an attempt to transfer the content; and
computer code for conditionally allowing the transfer, based on the signature and the context, wherein if the transfer is not allowed initially, an e-mail notification is sent and the transfer is delegated to an authoritative entity.

17. A system, comprising:
a hardware processor for identifying a signature for content, identifying a context of an attempt to transfer the content, and conditionally allowing the transfer, based on the signature and the context, wherein if the transfer is not allowed initially, an e-mail notification is sent and the transfer is delegated to an authoritative entity.

18. The system of claim 17, further comprising a database for storing the signature.

19. The system of claim 18, wherein the database is in communication with at least one security device.
